(19) United States
(12) Patent Application Publication
(10) Pub. No.: US 2024/0416637 A1
(43) Pub. Date: Dec. 19, 2024

(54) MEDICAL PAPER PRODUCTION APPARATUS AND PRODUCTION PROCESS

(71) Applicant: Jiangsu Pengqing Medical Technology Co., Ltd., Wuxi (CN)

(72) Inventors: Yinfeng SHI, Wuxi (CN); Min HAO, Wuxi (CN)

(73) Assignee: Jiangsu Pengqing Medical Technology Co., Ltd., Wuxi, JS (CN)

(21) Appl. No.: 18/694,988

(22) PCT Filed: Dec. 28, 2022
(86) PCT No.: PCT/CN2022/142576

§ 371 Date: Mar. 25, 2024

(30) Foreign Application Priority Data
Oct. 29, 2021 (CN) 202111269405.1

(51) Int. Cl. B32B 37/00; B32B 5/02; B32B 29/02; B32B 37/12; D04H 3/04; D04H 3/12

(52) U.S. Cl. CPC B32B 37/0053; B32B 5/028; B32B 29/02; B32B 37/12; D04H 3/04; D04H 3/12; B32B 2317/12; B32B 2535/00; D10B 2509/026

(57) ABSTRACT

Disclosed in the present invention is a medical paper production apparatus. The apparatus comprises a yarn mesh forming unit, a yarn mesh gluing unit, a yarn mesh, upper-layer medical paper, and lower-layer medical paper combining forming unit, an upper-layer medical paper unwinding unit, a lower-layer medical paper unwinding unit, and a composite medical paper winding unit which are sequentially provided on a rack; and the described units are respectively electrically connected to a PLC controller. According to the apparatus, a yarn is first woven into a grid-type yarn mesh; then the two surfaces of the yarn mesh are coated with a glue; then the yarn mesh is sandwiched between an upper-layer medical paper and a lower-layer medical paper; and then a pair of medical paper combining rolls are used to combine, by means of heating and pressurizing, the upper-layer medical paper, the yarn mesh, and the lower-layer medical paper into a medical multi-layer absorbent fiber reinforced material. The apparatus has a high degree of automation, can continuously produce medical tissues in batches, and can ensure firm combination of the yarn mesh to the upper-layer paper and the lower-layer paper, and uniform yarn grids; and the material forms a specific wrinkled effect by means of bidirectional shrinkage.

### TECHNICAL FIELD

The present invention relates to the technical field of medical paper production, in particular to a medical paper production apparatus and a production process.

### BACKGROUND ART

Medical multi-layer absorbent fiber reinforced material is a kind of special medical consumables for operating room, which is mainly used for cleaning hands before and after liquid cleaning during surgery, and wiping and cleaning of surgical instruments. It is also called “medical paper hand towel”, “medical absorbent paper”, “medical blood suction paper”, “medical washing paper”, “surgical paper towel” and “HandTowels” in the industry.

Medical paper belongs to Class I medical devices/consumables, and the production process shall comply with ISO13485 and MDD93/42 EU Medical Device Directive (EEC) quality management system and process with Good Manufacturing Standards (GMP) as the core.

Application: each disposable surgical gown is provided with 2 pieces, each standard surgical pack is provided with 5 pieces, and various functional combination surgical packs are provided with a plurality of pieces.

Multi-layer high-long fiber content raw wood paper and loose medical mesh material are compounded through specific process, and the material exerts a specific wrinkle foaming effect through bidirectional shrinkage to enhance the softness, comfort, absorption rate and tensile properties. It has the characteristics of high strength, strong absorption, safety, environmental protection, non-toxicity, no floc or allergy, and shall pass the biocompatibility test of ISO10993.

### SUMMARY OF THE INVENTION

One of the objectives of the present invention lies in overcoming the defects in the prior art, and providing a medical paper production apparatus which has high automation degree, can continuously produce medical paper in batches, can ensure that a yarn net of the medical paper is firmly compounded with an upper layer of paper and a lower layer of paper, has uniform yarn grids, and has a specific wrinkle foaming effect formed by bidirectional shrinkage of materials.

In order to achieve the above-mentioned objective, the technical solution of the present invention is to provide a medical paper production apparatus including a yarn net forming unit, a yarn net gluing unit, an upper layer medical paper and lower layer medical paper and yarn net compounding and forming unit, an upper layer medical paper unreeling unit, a lower layer medical paper unreeling unit and a compounded medical paper reeling unit which are successively arranged on a frame, and the units being respectively electrically connected to a PLC controller.

In order to achieve stable and continuous production of medical paper and meet the requirements of various technical indicators in the process of use, a preferred technical solution is that the yarn net forming unit includes a yarn spindle support and a first guide comb plate of an upper layer of warps, a guide comb plate of a middle layer of wefts and a guide comb plate of a lower layer of warps which are successively arranged on the frame, where a middle layer weft tensioning mechanism and a middle layer weft steering support which are hinged to the frame are provided at one side of the guide comb plate of the middle layer of wefts, a weft longitudinal conveying driving mechanism and a weft transverse driving mechanism connected to the frame are provided at one side of the guide comb plate of the lower layer of warps, a second guide comb plate of the upper layer of warps connected to the frame is further provided at one side of the weft transverse driving mechanism, and a gluing mechanism in a yarn net gluing unit is provided at the lower side of the side of the second guide comb plate of the upper layer of warps, a pair of compound compression rollers in a an upper layer medical paper and lower layer medical paper compounding and forming unit connected to the frame is provided at one side of the gluing mechanism, where the pair of compound compression rollers are used for clamping a yarn net composed of an upper layer of warps, a middle layer of wefts and a lower layer of warps between the upper layer of medical paper and the lower layer of medical paper; an upper layer medical paper unreeling support in an upper layer medical paper unreeling unit connected to the frame, a lower layer medical paper unreeling support in a lower layer medical paper unreeling unit and a reeling support in a compounded medical paper reeling unit are respectively provided at one side of the pair of compound compression rollers, and an upper layer medical paper unreeling tensioning mechanism connected to the frame is provided between the upper layer medical paper unreeling support and the pair of compound compression rollers; a lower layer medical paper unreeling tensioning mechanism connected to the frame is provided between the lower layer medical paper unreeling support and the pair of compound compression rollers, and a compounded medical paper reeling tensioning mechanism connected to the frame is provided between the reeling support and the pair of compound compression rollers.

In order to ensure that the yarn net runs at a constant speed and is clamped between two layers of medical paper so that the yarn net can run synchronously with the upper and lower layers of medical paper, a preferred technical solution is that the weft longitudinal conveying driving mechanism includes a pair of synchronous conveyor belts arranged in parallel on both sides of the frame, the pair of synchronous conveyor belts being wound between a pair of synchronous wheels, synchronous driving wheels in the pair of synchronous wheels driving the synchronous driving pulleys to engage with the synchronous conveyor belts via a driving shaft, synchronous driven wheels in the pair of synchronous wheels driving the synchronous driven wheels to engage with the synchronous conveyor belts via a driven shaft, and the driving shaft and the driven shaft are supported on the frame via a bearing and a bearing seat, one end of the driving shaft is connected to the driving motor, and the driving motor is electrically connected to the PLC controller; the driven shaft is arranged below the first guide comb plate on the frame; the driving shaft is arranged on the frame below the yarn net on one side after the medical paper is compounded with a pair of compound compression rollers; a plurality of weft hooks are uniformly distributed on a pair of synchronous conveyor belts, and the weft hooks are connected to the pair of synchronous conveyor belts via fasteners; the spacing between the weft hooks is equal to the spacing between the wefts of the yarn net, or is equal to an integer multiple of the spacing between the weft yarns of the yarn net; a yarn net weft unhooking mechanism or a weft cutting component is provided at the side of the synchronous conveyor belt after the medical paper is compounded by a pair of compound compression rollers.

In order to ensure that the yarn net runs at a constant speed and is clamped between two layers of medical paper so that the yarn net can run synchronously with the upper and lower layers of medical paper, a preferred technical solution is that the weft transverse conveying driving mechanism includes a pair of longitudinal supports connected to two sides of the frame, a transverse support is provided on the pair of longitudinal supports, and the transverse support drives the transverse support to reciprocate along the longitudinal supports via at least one pair of transverse support longitudinal driving mechanisms provided on the longitudinal supports; the transverse support is provided with a transverse driving assembly including a second synchronous conveyor belt arranged on the transverse support, the second synchronous conveyor belt is wound between a pair of synchronous wheels, a driving synchronous pulley in the pair of synchronous wheels is connected to a transverse driving motor via a driving shaft supported on the transverse support, and a driven synchronous pulley in the pair of synchronous wheels is supported on the transverse support via a driven shaft; a driving block is connected to the second synchronous conveyor belt, a longitudinal guide plate is connected to the driving block, and a plurality of transverse yarn guides arranged at equal intervals are connected to the longitudinal guide plate; the linear driving motor and the transverse driving motor are respectively electrically connected to the PLC controller.

In order to avoid the unevenness of the paper and the unevenness of the strength in each direction of the paper caused by the loosening of the yarn net or the desynchronized running of the upper and lower layers of medical paper caused by the loosening of the upper and lower layers of medical paper, a further preferred technical solution is that the middle layer weft tensioning mechanism, the upper layer medical paper unreeling tensioning mechanism and the lower layer medical paper unreeling tensioning mechanism respectively include a rotary shaft hingedly connected between two sides of the frame, a swing bracket is mounted on the rotary shaft, an elastic traction member is provided between one side of the swing bracket and the frame, and is wound on an angle sensor provided on the frame, the tensile force of the elastic traction member is set and memorized by the angle sensor electrically connected to the PLC controller.

In order to ensure that the tensile force at the reeling end of the medical paper always remains uniform and consistent, and the reeling tension of the medical paper still remains unchanged when the rotation speed of a pair of compound compression rollers changes, a preferred technical solution is that the compounded medical paper reeling tensioning mechanism includes a counterweight frame slidably fitted with a vertical stand column of the frame, a guide rod is provided on the counterweight frame, an elastic traction member is connected to one end of the counterweight frame and is wound on an angle sensor provided on the frame, the tensile force of the elastic traction member is set and memorized by the angle sensor, and the angle sensor is electrically connected to the PLC controller.

In order to ensure that the glue can be uniformly coated on both sides of the yarn net, a further preferred technical solution is that the gluing mechanism includes a glue groove mounted between two sides of the frame, a driving glue roller partially embedded in the glue groove is arranged on the glue groove, a glue roller driving motor is arranged on one side of the driving glue roller and is electrically connected to the PLC controller, and the other side of the driving glue roller is meshed with the driven wheel via a driving gear and is connected to the driven glue roller via a driven shaft, the driving glue roller is parallel to the driven glue roller and the roller surfaces are arranged tangentially on the frame, and the position where the roller surfaces of the driving glue roller are tangent to the driven glue roller corresponds to the position where the yarn net is arranged on the frame.

In order to facilitate the adjustment of the compounding temperature and compounding pressure of the upper and lower layers of paper and the yarn net clamped between the upper and lower layers of paper of the pair of compounding compression rollers, a preferred technical solution is that the pair of compound compression rollers includes an upper hollow compression roller and a lower hollow compression roller, the hollow interiors of the upper hollow compression roller and the lower hollow compression roller are provided with an electric heater and a temperature sensor electrically connected to the PLC controller, the two ends of the upper hollow compression roller and the lower hollow compression roller are respectively supported on the frame via an upper support seat and a lower support seat, a guide rod is provided between the upper support seat and the lower support seat, a top pressing block is provided at the upper end of the guide rod, a top pressing plate slidingly fitted with the guide rod is provided below the top pressing block, a top pressing spring is provided between the top pressing plate and the upper support seat, a screw hole is provided on the top pressing block, and the screw hole is in threaded engagement with a screw having one end pressed against the top pressing plate and the other end provided with a nut or an adjustment handle; one end of the upper hollow compression roller and the lower hollow compression roller are respectively provided with a driving gear and a driven gear meshed with each other, where the driving gear is connected to a compression roller driving motor via a flange, and the compression roller driving motor is electrically connected to the PLC controller.

In order to facilitate the mounting and fixation of the reeling support, the upper layer medical paper unreeling support and the lower layer medical paper unreeling support, and at the same time in order to avoid loosening and sagging of the paper during the conveyance process, a further preferred technical solution is that the reeling support, the upper layer medical paper unreeling support and the lower layer medical paper unreeling support of the compounded medical paper are all arranged between stand columns symmetrically arranged on the frame, a plurality of guide rollers are respectively arranged between the reeling support, the upper layer medical paper unreeling support and the lower layer medical paper unreeling support and a pair of compound compression rollers, and the reeling support is provided with a rolling driving mechanism; the reeling driving mechanism includes a reeling drum, a reeling mandrel is provided at the center of the reeling drum and is supported on the frame, one end of the reeling mandrel is connected to a reeling driving motor provided on the frame, and the reeling driving motor is electrically connected to the PLC controller.

An objective of the present invention also lies in overcoming the defects in the prior art, and providing a medical paper production process which has high automation degree, can continuously produce medical paper in batches, can ensure that a yarn net of the medical paper is firmly compounded with an upper layer of paper and a lower layer of paper, has uniform yarn grids, and has a specific wrinkle foaming effect formed by bidirectional shrinkage of materials.

In order to achieve the above objective, the technical solution of the present invention also provides a medical paper production process using the above-mentioned medical paper production apparatus, the production process including:
S1: placing the yarn spindle on a yarn spindle support;
S2: respectively placing the upper layer of medical paper and the lower layer of medical paper on the upper layer medical paper unreeling support and the lower layer medical paper unreeling support;
S3: leading the yarn on the yarn spindle support out, where a part of the yarn passes through the first warp comb plate of the upper layer of yarn, the second guide comb plate of the upper layer of yarn, the gluing mechanism and a pair of compound compression rollers, a part of the yarn passes through the guide comb plate of the lower layer of warps, the gluing mechanism and a pair of compound compression rollers, and a part of the yarn passes through the guide comb plate of the middle layer of wefts 5; the middle layer weft tensioning mechanism and the middle layer weft steering support are connected to a weft hook on a synchronous driving belt on a weft longitudinal driving mechanism and a weft transverse driving mechanism;
S4: injecting glue into the glue groove in the gluing mechanism;
S5: leading the upper layer of medical paper on the upper layer medical paper unreeling support out from the upper layer medical paper unreeling support and respectively passing through the upper layer medical paper unreeling tensioning mechanism and a pair of compound compression rollers, and leading the lower layer of medical paper on the lower layer medical paper unreeling support out from the lower layer medical paper unreeling support and respectively passing through the lower layer medical paper unreeling tensioning mechanism and a pair of compound compression rollers;
S6: leading the upper layer of medical paper, the yarn net and the lower layer of medical paper passing through the pair of compound compression rollers together to pass through the reeling tensioning mechanism and winding same on the reeling support, and after passing through the pair of compound compression rollers, separating the weft from the weft hook via an unhooking mechanism or a weft cutting component;
S7: respectively starting a reeling driving motor in a reeling driving mechanism on a reeling support, a compression roller driving motor in a pair of compound compression rollers, an electric heater in the pair of compound compression rollers, a glue roller driving motor in a gluing mechanism, a driving motor of a pair of synchronous belts in a weft longitudinal conveying driving mechanism and a transverse driving motor of a second synchronous conveyor belt in a weft transverse driving mechanism via the PLC controller;
S8: controlling the tension of the weft and the travelling speed of the weft by the PLC controller, and at the same time, controlling the unreeling tension of the upper layer of medical paper and the lower layer of medical paper and the reeling tension of the compounded medical paper by the PLC controller, and measuring and controlling the temperature of the electric heater in the pair of compound compression rollers by the PLC controller; and
S9: adjusting the pressure between the pair of compound compression rollers by manually adjusting a screw on a top pressing plate on the pair of compound compression rollers.

The advantages and benefits of the present invention are that the medical paper production apparatus can achieve continuous production in batches of medical paper, and the apparatus has a high degree of automation in production, stable quality in the continuous production process, high compound strength of the produced medical paper, high tensile strength in all directions and uniformly distributed, and uniform surface wrinkles, and no problems of paper scrap shedding. According to brief introduced to the production process of the medical paper. The product produced is uniform and consistent in quality, the upper layer of paper and the lower layer of paper are firmly combined with the yarn net. Both sides of the yarn net are uniformly glued. During the production process, the tensile force that the yarn net, the upper layer of paper, the lower layer of paper and the finished product paper are subjected to are uniform and adjustable, and the tension adjustment mechanism used is small, has high sensitivity and wide adjustment range. The compounding temperature and the compounding pressure between a pair of compounding compression rollers can be conveniently adjusted.

### BRIEF DESCRIPTION OF THE DRAWINGS

FIG. 1 is a schematic front view of a medical paper production apparatus according to the present invention;

FIG. 2 is a schematic diagram of the top view of FIG. 1;

FIG. 3 is a schematic front view of a longitudinal support driving mechanism for weft yarns in the medical paper production apparatus of FIG. 1;

FIG. 4 is a schematic plan view of a longitudinal support driving mechanism for weft yarns in the medical paper production apparatus of FIG. 1;

FIG. 5 is a schematic front view of a weft transverse driving mechanism in the medical paper production apparatus of FIG. 1;

FIG. 6 is a schematic plan view of a weft transverse driving mechanism in the medical paper production apparatus of FIG. 1;

FIG. 7 is a schematic front view of a pair of compound compression rollers in the medical paper production apparatus of FIG. 1;

FIG. 8 is a schematic rear view of a pair of compound compression rollers in the medical paper production apparatus of FIG. 1;

FIG. 9 is a schematic plan view of a pair of compound compression rollers in the medical paper production apparatus of FIG. 1;

FIG. 10 is a schematic front view of a gluing mechanism in the medical paper production apparatus of FIG. 1;

FIG. 11 is a schematic rear view of the gluing mechanism of the medical paper production apparatus of FIG. 1; and

FIG. 12 is a schematic plan view of a gluing mechanism in the medical paper production apparatus of FIG. 1.

In the figure: I. yarn net forming unit; II. yarn net gluing unit; III. upper layer medical paper and lower layer medical paper compounding and forming unit; IV. upper layer medical paper unreeling unit; V. lower layer medical paper unreeling unit; VI. formed medical paper reeling unit; 1. frame; 2. yarn spindle support; 3. upper layer of warp; 4. first guide comb plate; 5. middle layer of weft; 6. guide comb plate; 7. lower layer of warp; 8. guide comb plate; 9. middle layer weft tensioning mechanism; 10. middle layer weft steering support; 11. weft longitudinal conveying driving mechanism; 11.1. synchronous conveyor belt; 11.2. synchronous wheel; 11.21. synchronous driving pulley; 11.22. synchronous driven wheel; 11.3. driving shaft; 11.4. driven shaft; 11.5. driving motor; 11.6. weft hook; 11.7. weft unhooking component; 12. weft transverse driving mechanism; 12.1. longitudinal support; 12.2. transverse support; 12.3. transverse support longitudinal driving mechanism; 12.31. screw; 12.32. lead screw driving motor; 12.33. nut; 12.34. guide groove; 12.4. second synchronous conveyor belt; 12.5. driving synchronous pulley; 12.6. driving shaft; 12.7. transverse driving motor; 12.8. driven synchronous pulley; 12.9. driven shaft; 12.10. driving block; 12.11. transverse yarn guide; 12.12. transverse yarn guide; 13. second guide comb plate; 14. gluing mechanism; 14.1. glue groove; 14.2. driving glue roller; 14.3. glue roller driving motor; 14.4. driving gear; 14.5. driven gear; 14.6. driven glue roller; 15. upper layer of medical paper; 16. lower layer of medical paper; 17. a pair of compound compression rollers; 17.1. upper hollow compression roller; 17.2. lower hollow compression roller; 17.3. electric heater; 17.4. temperature sensor; 17.5. upper support seat; 17.6. lower support seat; 17.7. guide rod; 17.8. top pressing block; 17.9. top pressing plate; 17.10. top pressing spring; 17.11. screw; 17.12. adjustment handle; 17.13. driving gear; 17.14. driven gear; 17.15. flange; 17.16. compression roller driving motor; 18. yarn net; 19. upper layer medical paper unreeling support; 20. lower layer medical paper unreeling support; 21. compounded medical paper; 22. reeling support; 23. upper layer medical paper unreeling tensioning mechanism; 24. lower layer medical paper unreeling tensioning mechanism; 25. reeling tensioning mechanism; 26. rotary shaft; 27. swing bracket; 28. elastic traction member; 29. angle sensor; 30. counterweight frame; 31. guide rod; 32. elastic traction member; 33. angle sensor; 34. guide roller; 35. reeling driving mechanism; 35.1. reeling drum; 35.2. reeling mandrel; 35.3. reeling driving motor.

### DETAILED DESCRIPTION OF THE INVENTION

Particular embodiments of the present invention are further described below with reference to the drawings and examples. The following examples are provided only to illustrate the technical solution of the present invention more clearly, and are not intended to limit the scope of the present invention.

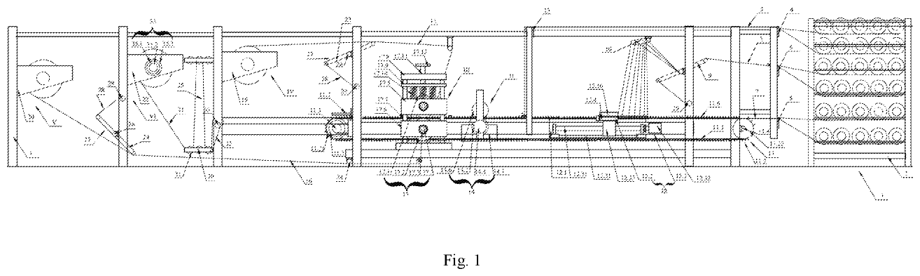

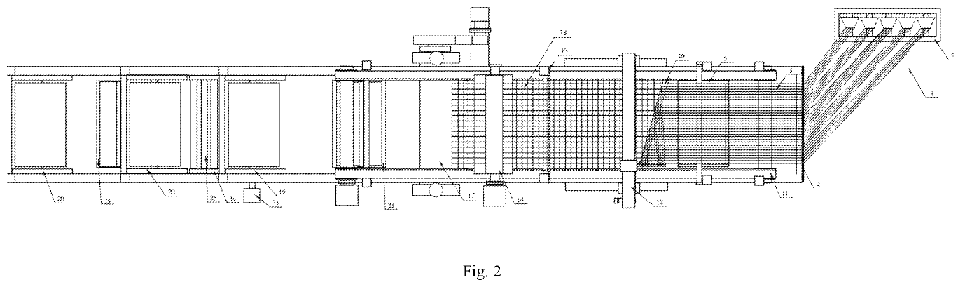

As shown in FIGS. 1 and 2, the present invention is a medical paper production apparatus including a yarn net forming unit I, a yarn net gluing unit II, an upper layer medical paper and lower layer medical paper compounding and forming unit III, a upper layer medical paper reeling unit IV, a lower layer medical paper unreeling unit V and a formed medical paper reeling unit VI which are successively arranged on a frame 1, and the units being respectively electrically connected to a PLC controller (not shown in the figures).

In order to achieve stable and continuous production of medical paper and meet the requirements of various technical indexes in the process of use, a preferred embodiment of the present invention is that, as shown in FIGS. 1 and 2, the yarn net forming unit I includes a yarn spindle support 2 and a first guide comb plate 4 of an upper layer of warps 3, a guide comb plate 6 of a middle layer of wefts 5 and a guide comb plate 8 of a lower layer of warps 7 which are successively arranged on the frame 1, wherein a middle layer weft tensioning mechanism 9 and a middle layer weft steering support 10 which are hinged to the frame 1 are provided at one side of the guide comb plate 6 of the middle layer of wefts, a weft longitudinal conveying driving mechanism 11 and a weft transverse driving mechanism 12 connected to the frame 1 are provided at one side of the guide comb plate 8 of the lower layer of warps 7, a second guide comb plate 13 of the upper layer of warps 3 connected to the frame 1 is further provided at one side of the weft transverse driving mechanism 12, and a gluing mechanism 14 in a yarn net gluing unit II is provided at the lower side of the side of the second guide comb plate 13 of the upper layer of warps 3, a pair of compound compression rollers 17 in an upper layer medical paper 15 and lower layer medical paper 16 compounding and forming unit III connected to the frame 1 is provided at one side of the gluing mechanism 14, wherein the pair of compound compression rollers 17 are used for clamping a yarn net 18 composed of an upper layer of warps 3, a middle layer of wefts 5 and a lower layer of warps 7 between the upper layer of medical paper 15 and the lower layer of medical paper 16; an upper layer medical paper unreeling support 19 in an upper layer medical paper unreeling unit IV connected to the frame 1, a lower layer medical paper unreeling support 20 in a lower layer medical paper unreeling unit V and a reeling support 22 in a compounded medical paper 21 reeling unit VI are respectively provided at one side of the pair of compound compression rollers 17, and an upper layer medical paper unreeling tensioning mechanism 23 connected to the frame 1 is provided between the upper layer medical paper unreeling support 19 and the pair of compound compression rollers 17; a lower layer medical paper unreeling tensioning mechanism 24 connected to the frame 1 is provided between the lower layer medical paper unreeling support 20 and the pair of compound compression rollers 17, and a reeling tensioning mechanism 25 of the compounded medical paper 21 connected to the frame 1 is provided between the reeling support 22 and the pair of compound compression rollers 17.

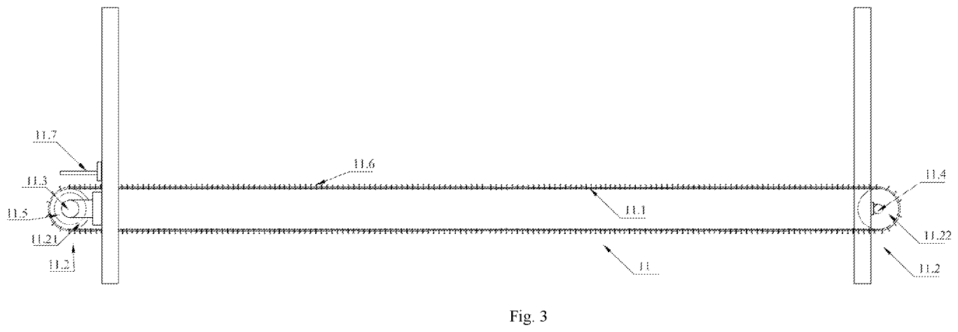

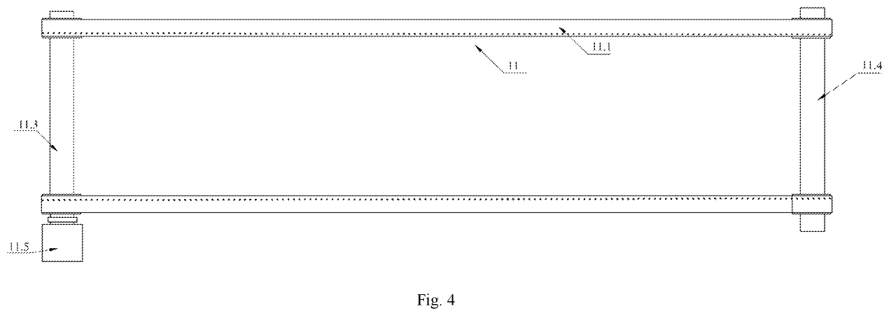

In order to ensure that the yarn net runs at a constant speed and is clamped between two layers of medical paper so that the yarn net can run synchronously with the upper and lower layers of medical paper, a preferred embodiment of the present invention further includes that, as shown in FIGS. 3 and 4, the weft longitudinal conveying driving mechanism 11 comprises a pair of synchronous conveyor belts 11.1 arranged in parallel on both sides of the frame 1 and wound between a pair of synchronous wheels 11.2, a synchronous driving wheel in the pair of synchronous wheels 11.2 driving a synchronous driving pulley 11.21 to engage with the synchronous conveyor belt 11.1 via a driving shaft 11.3, a synchronous driven wheel 11.22 in the pair of synchronous wheels 11.2 drives the synchronous driven wheel 11.22 to mesh with the synchronous conveyor belt 11.1 via the driven shaft 11.4, the driving shaft 11.3 and the driven shaft 11.4 are supported on the frame 1 via a bearing and a bearing seat, one end of the driving shaft 11.3 is connected to the driving motor 11.5 electrically connected to the PLC controller, and the driven shaft 11.4 is arranged below the first guide comb plate 4 on the frame; the driving shaft 11.3 is arranged on the frame below the yarn net 18 on one side after the medical paper is compounded by the pair of compound compression rollers 17, a plurality of weft hooks 11.6 are uniformly distributed on the pair of synchronous conveyor belts 11.1 and are connected to the pair of weft hooks 11.6 via fasteners, and the spacing between the weft hooks 11.6 is equal to the spacing between the wefts of the yarn net 18, or is equal to an integer multiple of the spacing between the weft yarns of the yarn net 18; a yarn net 18 weft unhooking mechanism or a weft cutting component 11.7 is provided at one side of the synchronous conveyor belt 11.1 after the medical paper is compounded by a pair of compounding compression rollers 17.

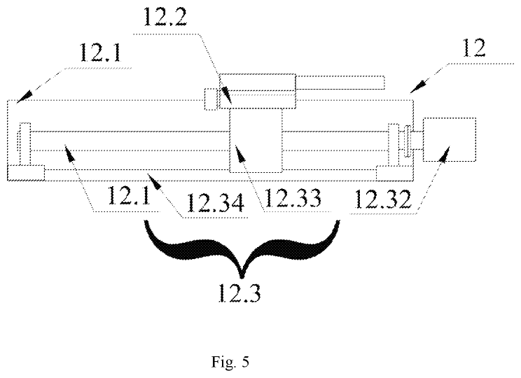

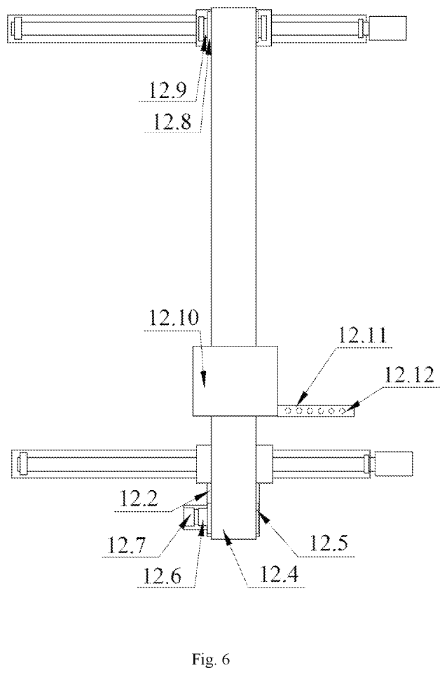

In order to ensure that the yarn net 18 runs at a constant speed and is clamped between two layers of medical paper so that the yarn net 18 can run synchronously with the upper and lower layers of medical paper, a preferred embodiment of the present invention further includes, as shown in FIGS. 5 and 6, the weft transverse conveying driving mechanism 12 includes a pair of longitudinal supports 12.1 connected to two sides of the frame 1, and a transverse support 12.2 is provided on the pair of longitudinal supports 12.1. The transverse support 12.2 drives the transverse support 12.2 to reciprocate along the longitudinal supports 12.1 via at least one pair of transverse support longitudinal driving mechanisms 12.3 provided on the longitudinal support 12.1, where the transverse support longitudinal driving mechanism 12.3 can use a lead screw nut driving mechanism, where the vicinity of two ends of the screw 12.31 is connected to the frame 1 via a bearing and a bearing seat, where one end of the lead screw 12.31 is also connected to the lead screw driving motor 12.32, and the lead screw driving motor 12.32 is also connected to the frame 1 and is electrically connected to the PLC controller; the nut 12.33 in the screw nut driving mechanism is in threaded engagement with the lead screw 12.31, one side of the outside of the nut 12.33 is connected to the transverse support 12.2, and the other side of the outside of the nut 12.33 is in sliding engagement with the guide groove 12.34 provided on the frame; of course, the longitudinal support driving mechanism 12.3 of the pair of transverse supports can also be driven by a linear motor, or by a gear-rack driving mechanism, or by a crank-rocker driving mechanism, or by a synchronous belt and a synchronous pulley, etc. The transverse support 12.2 is provided with a transverse driving assembly, where the transverse driving assembly includes a second synchronous conveyor belt 12.4 arranged on the transverse support 12.2, the second synchronous conveyor belt 12.4 is wound between a pair of synchronous wheels, a driving synchronous pulley 12.5 in the pair of synchronous wheels is connected to a transverse driving motor 12.7 via a driving shaft 12.6 supported on the transverse support 12.2, and a driven synchronous pulley 12.8 in the pair of synchronous wheels is supported on the transverse support 12.2 via a driven shaft 12.9; a transverse driving block 12.10 is connected to the second synchronous conveyor belt 12.4, a transverse yarn guide plate 12.11 is connected to the driving block 12.10, and a plurality of transverse yarn guides 12.12 arranged at equal intervals are connected to the transverse yarn guide plate 12.11; the lead screw driving motor 12.32 and the transverse driving motor 12.7 are electrically connected to the PLC controller, respectively.

In order to avoid the unevenness of the paper and the unevenness of the strength in each direction of the paper caused by the loosening of the yarn net 18 or the asynchronous movement of the upper and lower layers of medical paper 15 and 16 and the yarn net 18 caused by the loosening of the upper layer and lower layer of medical paper 15 and 16, a further preferred embodiment of the present invention is that, as shown in FIGS. 1 and 2, the middle layer weft tensioning mechanism 9, the upper layer medical paper unreeling tensioning mechanism 23 and the lower layer medical paper unreeling tensioning mechanism 24 respectively comprise a rotary shaft 26 hingedly connected between two sides of the frame 1, a swing bracket 27 is mounted on the rotary shaft 16, an elastic traction member 28 is provided between one side of the swing bracket 27 and the frame 1, and is wound on an angle sensor 29 provided on the frame 1, the tensile force of the elastic traction member 28 is set and memorized by the angle sensor 29 electrically connected to the PLC controller.

In order to ensure that the tensile force at the reeling end of the medical paper always remains uniform and consistent, and the reeling tension of the medical paper still remains unchanged when the rotation speed of a pair of compound compression rollers 17 changes, a preferred embodiment of the present invention is that, as shown in FIGS. 1 and 2, the reeling tensioning mechanism 25 of the compounded medical paper 21 includes a counterweight frame 30 slidably fitted with a vertical stand column of the frame 1, a guide rod 31 is provided on the counterweight frame 30, an elastic traction member 32 is connected to one end of the counterweight frame 30 and is wound on an angle sensor 33 provided on the frame 1, the tensile force of the elastic traction member 32 is set and memorized by the angle sensor 33, and the angle sensor 33 is electrically connected to the PLC controller.

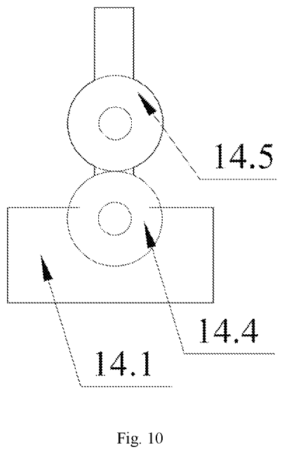

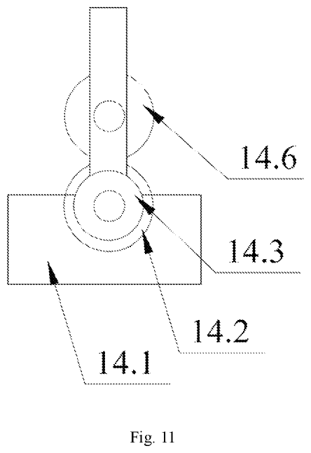

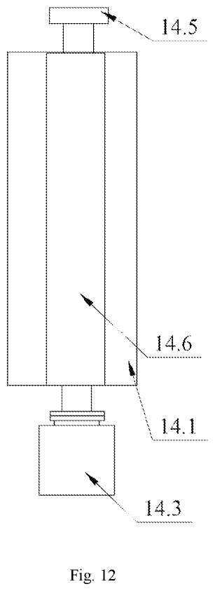

In order to ensure uniform application of glue on both sides of the yarn net 18, a preferred embodiment of the present invention further includes that, as shown in FIGS. 10, 11 and 12, the gluing mechanism 14 includes a glue groove 14.1 mounted between two sides of the frame 1, a driving glue roller 14.2 partially embedded in the glue groove 14.1 is arranged on the glue groove 14.1, a glue roller driving motor 14.3 is arranged on one side of the driving glue roller 14.2 and is electrically connected to the PLC controller, and the other side of the driving glue roller 14.2 is meshed with the driven gear 14.5 via a driving gear 14.4 and is connected to the driven glue roller 14.6 via a driven shaft, the driving glue roller 14.2 is parallel to the driven glue roller 14.6 and the roller surfaces are arranged tangentially on the frame 1, and the position where the roller surfaces of the driving glue roller 14.2 are tangent to the driven glue roller 14.6 corresponds to the position where the yarn net 18 is arranged on the frame 1.

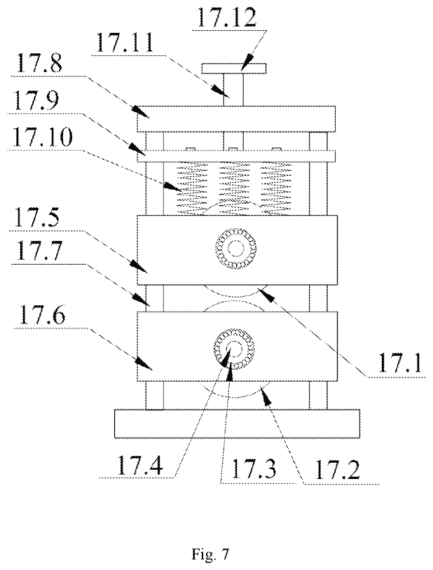

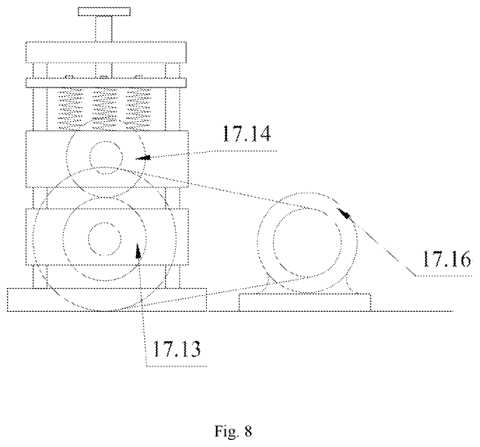

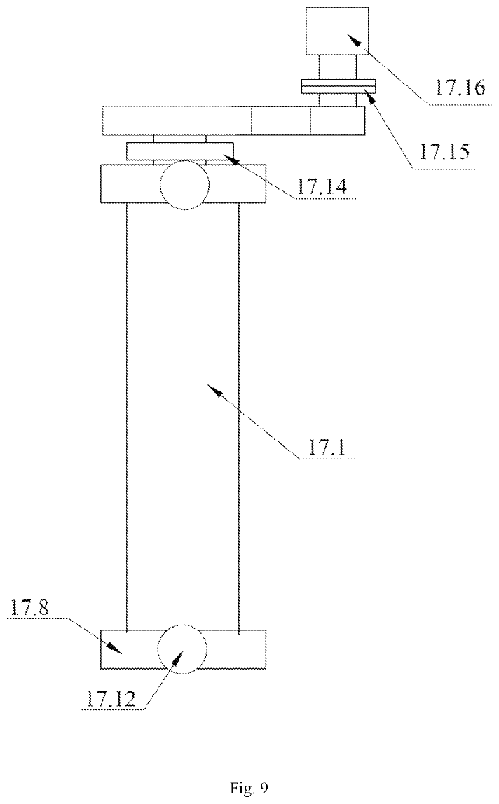

In order to facilitate the adjustment of the compounding temperature and the compounding pressure of the pair of compound compression rollers 17 on the compounded upper layer of and lower layer of paper 15, 16 and the yarn net 18 clamped between the upper layer of and lower layer of paper, a preferred embodiment of the present invention is that, as shown in FIGS. 7, 8 and 9, the pair of compound compression rollers 17 comprises an upper hollow compression roller 17.1 and a lower hollow compression roller 17.2, the hollow interiors of the upper hollow compression roller 17.1 and the lower hollow compression roller 17.2 are provided with an electric heater 17.3 and a temperature sensor 17.4 electrically connected to the PLC controller, the two ends of the upper hollow compression roller 17.1 and the lower hollow compression roller 17.2 are respectively supported on the frame 1 via an upper support seat 17.5 and a lower support seat 17.6, a guide rod 17.7 is provided between the upper support seat 17.5 and the lower support seat 17.6, a top pressing block 17.8 is provided at the upper end of the guide rod 17.7, a top pressing plate 17.9 slidingly fitted with the guide rod 17.7 is provided below the top pressing block 17.8, a top pressing spring 17.10 is provided between the top pressing plate 17.9 and the upper support seat 17.5, a screw hole is provided on the top pressing block 17.8, and the screw hole is in threaded engagement with a screw 17.11 having one end pressed against the top pressing plate 17.9 and the other end provided with a nut or an adjustment handle 17.12; one end of the upper hollow compression roller 17.1 and the lower hollow compression roller 17.2 are respectively provided with a driving gear 17.13 and a driven gear 17.14 meshed with each other, wherein the driving gear 17.13 is connected to a compression roller driving motor 17.16 via a flange 17.15, and the compression roller driving motor 17.16 is electrically connected to the PLC controller.

In order to facilitate the mounting and fixing of the reeling support 22, the upper layer medical paper unreeling support 19 and the lower layer medical paper unreeling support 20, and at the same time, in order to avoid the paper from loosening and sagging during the conveyance process, a preferred embodiment of the present invention further includes: as shown in FIGS. 1 and 2, the reeling support 22, the upper layer medical paper unreeling support 19 and the lower layer medical paper unreeling support 20 of the compounded medical paper are all arranged between stand columns symmetrically arranged on the frame 1, a plurality of guide rollers 34 are respectively arranged between the reeling support 22, the upper layer medical paper unreeling support 19 and the lower layer medical paper unreeling support 20 and a pair of compound compression rollers 17, and the reeling support 22 is provided with a rolling driving mechanism 35; the reeling driving mechanism 35 comprises a reeling drum 35.1, a reeling mandrel 35.2 is provided at the center of the reeling drum 35.1 and is supported on the frame 1, one end of the reeling mandrel 35.2 is connected to a reeling driving motor 35.3 provided on the frame 1, and the reeling driving motor 35.3 is electrically connected to the PLC controller.

Another objective of the present invention also lies in overcoming the defects in the prior art, and providing a medical paper production process which has high automation degree, can continuously produce medical paper in batches, can ensure that a yarn net 18 of the medical paper is firmly compounded with an upper layer of paper 15 and a lower layer of paper 16, has uniform yarn nets 18, and has a specific wrinkle foaming effect formed by bidirectional shrinkage of materials.

In order to achieve the above objective, the technical solution of the present invention also provides a medical paper production process using the above-mentioned medical paper production apparatus, the production process including:
S1: the yarn spindle was placed on a yarn spindle support 2;
S2: the upper layer of medical paper 15 and the lower layer of medical paper 16 were respectively placed on the upper layer medical paper unreeling support 19 and the lower layer medical paper unreeling support 20;
S3: the yarn on the yarn spindle support 2 was led out, wherein a part of the yarn passed through the first warp comb plate 4 of the upper layer of yarn 3, the second guide comb plate 13 of the upper layer of yarn 3, the gluing mechanism 14 and a pair of compound compression rollers 17, a part of the yarn passed through the guide comb plate 8 of the lower layer of warps 7, the gluing mechanism 14 and a pair of compound compression rollers 17, and a part of the yarn passed through the guide comb plate 6 of the middle layer of wefts 5; the middle layer weft tensioning mechanism 9 and the middle layer weft steering support 10 were connected to a weft hook 11.6 on a synchronous driving belt 11.21 on a weft longitudinal driving mechanism 11 and a weft transverse driving mechanism 12;
S4: glue was injected into the glue groove 14.1 in the gluing mechanism 14;
S5: the upper layer of medical paper 15 on the upper layer medical paper unreeling support 19 was led out from the upper layer medical paper unreeling support 19 and were respectively passed through the upper layer medical paper unreeling tensioning mechanism 23 and a pair of compound compression rollers 17, and the lower layer of medical paper 16 on the lower layer medical paper unreeling support 20 was led out from the lower layer medical paper unreeling support 20 and were respectively passed through the lower layer medical paper unreeling tensioning mechanism 24 and a pair of compound compression rollers 17;
S6: the upper layer of medical paper 15, the yarn net 18 and the lower layer of medical paper 16 passing through the pair of compound compression rollers 17 together were led to pass through the reeling tensioning mechanism 25 and were wound on the reeling support 22, and after passing through the pair of compound compression rollers 17, the weft 18 was separated from the weft hook 11.6 via an unhooking mechanism or a weft cutting component;
S7: a reeling driving motor 35.5 in a reeling driving mechanism 35 on a reeling support 22, a compression roller driving motor 17.16 in a pair of compound compression rollers 17, an electric heater 17.3 in the pair of compound compression rollers 17, a glue roller driving motor 14.3 in a gluing mechanism 14, a driving motor 11.5 of a pair of synchronous belts 11.1 in a weft longitudinal conveying driving mechanism 11 and a transverse driving motor 12.7 of a second synchronous conveyor belt 12.4 in a weft transverse driving mechanism 12 were respectively started via the PLC controller;
S8: the tension of the weft and the traveling speed of the weft were controlled by the PLC controller, and at the same time, the unreeling tension of the upper layer of medical paper 15 and the lower layer of medical paper 16 and the reeling tension of the compounded medical paper 21 were controlled by the PLC controller, and the temperature of the electric heater 17.3 in the pair of compound compression rollers 17 was measured and controlled by the PLC controller; and
S9: the pressure between the pair of compound compression rollers 17 was adjusted by manually adjusting a screw 17.11 on a top pressing plate 17.9 on the pair of compound compression rollers 17.

The working principle of this medical paper production apparatus is:
the apparatus first weaves a yarn into a yarn net of a net format, and then coats and glues both sides of the yarn net, and then clamps the yarn net between an upper layer of medical paper and a lower layer of medical paper, and then combines the upper layer of medical paper, the yarn net and the lower layer of medical paper into a medical multi-layer absorbent fiber reinforced material by heating and pressing with a pair of medical paper compounding rollers.

The yarn spindle support is used for placing a yarn spindle for knitting a yarn net.

The frame is a frame structure used for the mounting or support of various components on the apparatus.

A first guide comb plate is mounted at the end near one side of the yarn spindle support for orderly guiding of the upper layer of radial yarns.

The guide comb plate of the middle layer of wefts is mounted at the end near one side of the yarn spindle support for orderly guide of the weft to weft.

A guide comb plate for the lower layer of warps is mounted at the end close to one side of the yarn spindle support for the orderly guiding of the lower radial yarns at the position where the yarn net is formed.

The middle layer weft tensioning mechanism is a set of components for adjusting and controlling the tension of the weft yarns. The middle layer weft steering support is used to rotate the yarns introduced in the direction of the eye warp by 90 deg. through the middle layer weft steering support for the entire row of yarns.

The weft longitudinal conveying driving mechanism is a set of components used for driving the weft yarns in the yarn net to move at a uniform speed in the direction of a pair of medical paper compounding rollers, and the set of components mainly includes a pair of synchronous conveyor belts which are respectively engaged with a driving synchronous wheel and a driven synchronous wheel, where the driving synchronous wheel is connected to a driving shaft, the driven synchronous wheel is connected to the driven synchronous wheel is connected to the driven shaft, the driving shaft and the driven shaft are respectively supported on the frame via a bearing and a bearing seat, and one end of the driving shaft is also connected to a longitudinal driving motor for longitudinally moving the weft yarns; the starting/stopping and rotating speed of the longitudinal driving motor are controlled by PLC controller, and the longitudinal driving motor can be selected as a servo motor. The driven shaft may be mounted on the frame below the yarn net near one end of the spindle support, and the driving shaft may be mounted on the frame on one side of the frame behind the medical paper compounding roller pair, parallel to the driven shaft, and of equal height. On one side of the synchronous belt, there is no meshing tooth side edge, and weft hooks are uniformly distributed on the non-meshing tooth side edge, and the weft hooks are fixedly connected to the non-meshing tooth side edge on the synchronous belt via a fixing member. After passing through a pair of medical paper compounding rollers, the yarn net needs to separate the weft yarn from the hook, and the way of separation can be cutting, burning, or turning the hook side, etc. The above-mentioned different unhooking ways can be respectively completed by selecting different structural members, such as a cutting knife, electric heating burning, hook side turning driving components, etc.

The weft transverse driving mechanism is a set of components used to secure the weft yarns to the weft hooks on the weft longitudinal conveying driving mechanism. The weft transverse driving mechanism needs to lead the weft yarn to reciprocate between a pair of synchronous conveyor belts in the weft longitudinal conveying driving mechanism, and the weft yarn can be guided to the weft hook on a pair of conveyor belts by leading the reciprocating motion of a row of a plurality of weft yarns by the weft transverse driving mechanism. The weft reciprocating driving motor in the weft transverse driving mechanism, under the control of the PLC controller, not only ensures that the weft hook is accurately hooked up, but also needs to ensure that it is synchronized with the speed of the weft longitudinal support driving mechanism driving the yarn net longitudinal movement. It is therefore necessary to provide in the weft transverse driving mechanism both a driving component for driving the wefts to reciprocate longitudinally, i.e., a transverse support longitudinal driving mechanism, so that the wefts thereof move synchronously with the longitudinal synchronous conveyor belt during hooking thereof. A transverse driving mechanism is also provided to cause the wefts to reciprocate on a pair of longitudinal synchronous conveyor belts to connect the wefts to the hooks.

In addition, the radial yarn is moved by a pair of medical paper compounding rollers in a direction of the pair of medical paper compound compression rollers by pulling the warp, where the speed of the warp moving in the direction of the pair of medical paper compound compression rollers is synchronized with the speed of the weft yarn moving in the direction of the pair of medical paper compound compression rollers during the process of compounding the medical paper.

The second guide comb plate of the upper layer of warps is used for ensuring that the upper layer of warps is continuously maintained at the upper layer of the frame and the spacing between the radial yarns is kept unchanged; after passing through the second guide comb plate of the upper layer of warps, the upper layer of warps will be transferred from the upper layer of the frame to the plane position where the yarn net is located, and the weft yarns on the lower layer of radial yarns are covered with the upper layer of radial yarns to form a yarn net structure in which the weft yarns are clamped between the upper layer of radial yarns and the lower layer of warps.

The gluing mechanism is used for attaching a gluing liquid on both sides of the yarn net, and for respectively bonding and compounding the upper layer of medical paper and the lower layer of medical paper together. The gluing mechanism mainly clamps the yarn net between a pair of glue rollers through the relative rolling of the pair of glue rollers on the glue groove to realize the process of gluing the two sides of the yarn net; one of the pair of glue rollers is a driving glue roller, and the other is a driven glue roller; the driving glue roller is connected to a glue roller driving motor; and the glue roller driving motor is electrically connected to the PLC controller.

A pair of compound compression rollers are key components in compounding the medical paper, and are used for clamping the yarn net composed of the upper layer of warps, the middle layer of wefts and the lower layer of warps between the upper layer of medical paper and the lower layer of medical paper; the pair of compound compression rollers need to be heated and pressurized to clamp the yarn net composed of the upper layer of warps, the middle layer of wefts and the lower layer of warps between the upper layer of medical paper and the lower layer of medical paper to prepare the medical paper. The upper layer of medical paper, the yarn net and the lower layer of medical paper can be heated to cause bidirectional shrinkage for the yarn net and the multi-layer high-long fiber content raw wood paper, so that the compounded medical paper forms a specific wrinkle foaming effect and enhances the softness, comfort, absorption capacity and tensile properties. It has the characteristics of high strength, strong absorption, safety, environmental protection, non-toxicity, no flocculation and no allergy. A hollow roll structure is used for a pair of compound compression rollers in order to facilitate the mounting of heaters in the compound compression rollers. In order to facilitate the adjustment of the pressure or spacing between a pair of compound compression rollers, a pressure adjustment component and a driving and transmission component are provided at the connecting portion between the pair of compound compression rollers and the frame, where the pressure adjustment component uses a sliding block sliding along a guide rod, and pressure adjustment components such as a spring top pressing block, a fixed pressing plate and a top pressing adjustment bolt or a top pressing cylinder provided on the sliding block, and the driving component and the transmission component are suitable for driving the pair of compound compression rollers to rotate relative to each other, and a gear transmission can be selected.

The upper layer medical paper unreeling support and the lower layer medical paper unreeling support are respectively used for placing the reeled raw medical paper on the support, making it easy to assemble and disassemble and easy to fix, so that it will not fall off during the unreeling process.

The reeling support is used for reeling the compounded medical paper into a paper roll, and also has the function of pulling the compounded medical paper; therefore, a reeling driving shaft and a reeling driving motor connected to the reeling driving shaft should also be provided on the reeling support, and the reeling driving motor is electrically connected to the PLC controller.

The upper layer medical paper unreeling tensioning mechanism is used to ensure that the upper layer of medical paper always maintains a certain tension during the unreeling process, and the setting and adjustment of the tension can be achieved by means of a spring or by means of a traction rope wound on an angle sensor, and the telescopic position or length of the traction rope can be memorized.

The lower layer medical paper unreeling tensioning mechanism is used to ensure that the lower layer of medical paper always maintains a certain tension during the unreeling process, and the setting and adjustment of the tension can be achieved by means of a spring or by means of a traction rope wound on an angle sensor, and the telescopic position or length of the traction rope can be memorized.

The reeling tensioning mechanism is used to ensure that the compounded medical paper always maintains a certain tension during the reeling process, and the setting and adjustment of the tension can be achieved by means of a spring or by means of a traction rope wound on an angle sensor, and the telescopic position or length of the traction rope can be memorized.

The frame may adopt a frame structure, or a baffle or a cabinet may be mounted on the outside of the frame, and a plurality of support rods or guide rods may be provided on the frame as required for supporting or guiding yarns, or upper and lower layers of medical paper and compounded medical paper.

While the foregoing is directed to the preferred embodiments of the present invention, it will be understood by a person skilled in the art that various changes may be made and equivalents may be substituted for elements thereof without departing from the scope of the present invention.

1. A medical paper production apparatus, comprising a yarn net forming unit (I), a yarn net gluing unit (II), an upper layer medical paper and lower layer medical paper compounding and forming unit, an upper layer medical paper unreeling unit (IV), a lower layer medical paper unreeling unit (V) and a compounded medical paper reeling unit (VI) which are successively arranged on a frame (1), and the units being respectively electrically connected to a PLC controller.

2. The medical paper production apparatus according to claim 1, wherein the yarn net forming unit (I) comprises a yarn spindle support (2) and a first guide comb plate (4) of an upper layer of warps (3), a guide comb plate (6) of a middle layer of wefts (5) and a guide comb plate (8) of a lower layer of warps (7) which are successively arranged on the frame (1), wherein a middle layer weft tensioning mechanism (9) and a middle layer weft steering support (10) which are hinged to the frame (1) are provided at one side of the guide comb plate (6) of the middle layer of wefts, a weft longitudinal conveying driving mechanism (11) and a weft transverse driving mechanism (12) connected to the frame (1) are provided at one side of the guide comb plate (8) of the lower layer of warps (7), a second guide comb plate (13) of the upper layer of warps (3) connected to the frame (1) is further provided at one side of the weft transverse driving mechanism (12), and a gluing mechanism (14) in a yarn net gluing unit (II) is provided at the lower side of the side of the second guide comb plate (13) of the upper layer of warps (3), a pair of compound compression rollers (17) in a an upper layer medical paper (15) and lower layer medical paper (16) compounding and forming unit (III) connected to the frame (1) is provided at one side of the gluing mechanism (14), wherein the pair of compound compression rollers (17) are used for clamping a yarn net (18) composed of an upper layer of warps (3), a middle layer of wefts (5) and a lower layer of warps (7) between the upper layer of medical paper (15) and the lower layer of medical paper (16); an upper layer medical paper unreeling support (19) in an upper layer medical paper unreeling unit (IV) connected to the frame (1), a lower layer medical paper unreeling support (20) in a lower layer medical paper unreeling unit (V) and a reeling support (22) in a compounded medical paper (21) reeling unit (VI) are respectively provided at one side of the pair of compound compression rollers (17), and an upper layer medical paper unreeling tensioning mechanism (23) connected to the frame (1) is provided between the upper layer medical paper unreeling support (19) and the pair of compound compression rollers (17); a lower layer medical paper unreeling tensioning mechanism (24) connected to the frame (1) is provided between the lower layer medical paper unreeling support (20) and the pair of compound compression rollers (17), and a reeling tensioning mechanism (25) of the compounded medical paper (21) connected to the frame 1 is provided between the reeling support (22) and the pair of compound compression rollers (17).

3. The medical paper production apparatus according to claim 2, wherein the weft longitudinal conveying driving mechanism (11) comprises a pair of synchronous conveyor belts (11.1) arranged in parallel on both sides of the frame (1) and wound between a pair of synchronous wheels (11.2), a synchronous driving wheel in the pair of synchronous wheels (11.2) driving a synchronous driving pulley (11.21) to engage with the synchronous conveyor belt (11.1) via a driving shaft (11.3), a synchronous driven wheel (11.22) in the pair of synchronous wheels (11.2) drives the synchronous driven wheel (11.22) to mesh with the synchronous conveyor belt (11.1) via the driven shaft (11.4), the driving shaft (11.3) and the driven shaft (11.4) are supported on the frame (1) via a bearing and a bearing seat, one end of the driving shaft (11.3) is connected to the driving motor (11.5) electrically connected to the PLC controller, and the driven shaft (11.4) is arranged below the first guide comb plate (4) on the frame; the driving shaft (11.3) is arranged on the frame below the yarn net (18) on one side after the medical paper is compounded by the pair of compound compression rollers (17), a plurality of weft hooks (11.6) are uniformly distributed on the pair of synchronous conveyor belts (11.1) and are connected to the pair of weft hooks (11.6) via fasteners, and the spacing between the weft hooks (11.6) is equal to the spacing between the wefts of the yarn net (18), or is equal to an integer multiple of the spacing between the weft yarns of the yarn net (18); a yarn net (18) weft unhooking mechanism or a weft cutting component (11.7) is provided at one side of the synchronous conveyor belt (11.1) after the medical paper is compounded by a pair of compounding compression rollers (17).

4. The medical paper production apparatus according to claim 2, wherein the weft transverse conveying driving mechanism (12) comprises a pair of longitudinal supports (12.1) connected to two sides of the frame (1), a transverse support (12.2) is provided on the pair of longitudinal supports (12.1), and the transverse support (12.2) drives the transverse support (12.2) to reciprocate along the longitudinal supports (12.1) via at least one pair of transverse support longitudinal driving mechanisms (12.3) provided on the longitudinal supports (12.1); the transverse support (12.2) is provided with a transverse driving assembly comprising a second synchronous conveyor belt (12.4) arranged on the transverse support (12.2), the second synchronous conveyor belt (12.4) is wound between a pair of synchronous wheels, a driving synchronous pulley (12.5) in the pair of synchronous wheels is connected to a transverse driving motor (12.7) via a driving shaft (12.6) supported on the transverse support (12.2), and a driven synchronous pulley (12.8) in the pair of synchronous wheels is supported on the transverse support (12.2) via a driven shaft (12.9); a driving block (12.10) is connected to the second synchronous conveyor belt (12.4), a longitudinal guide plate (12.11) is connected to the driving block (12.10), and a plurality of transverse yarn guides (12.12) arranged at equal intervals are connected to the longitudinal guide plate (12.11); the linear driving motor (12.3) and the transverse driving motor (12.7) are respectively electrically connected to the PLC controller.

5. The medical paper production apparatus according to claim 2, wherein the middle layer weft tensioning mechanism (9), the upper layer medical paper unreeling tensioning mechanism (23) and the lower layer medical paper unreeling tensioning mechanism (24) respectively comprise a rotary shaft (26) hingedly connected between two sides of the frame (1), a swing bracket (27) is mounted on the rotary shaft (16), an elastic traction member (28) is provided between one side of the swing bracket (17) and the frame (1), and is wound on an angle sensor (29) provided on the frame (1), the tensile force of the elastic traction member (28) is set and memorized by the angle sensor (29) electrically connected to the PLC controller.

6. The medical paper production apparatus according to claim 2, wherein the reeling tensioning mechanism (25) of the compounded medical paper (21) comprises a counterweight frame (30) slidably fitted with a vertical stand column of the frame (1), a guide rod (31) is provided on the counterweight frame (30), an elastic traction member (32) is connected to one end of the counterweight frame (30) and is wound on an angle sensor (33) provided on the frame (1), the tensile force of the elastic traction member (32) is set and memorized by the angle sensor (33), and the angle sensor (33) is electrically connected to the PLC controller.

7. The medical paper production apparatus according to claim 2, wherein the gluing mechanism (14) comprises a glue groove (14.1) mounted between two sides of the frame (1), a driving glue roller (14.2) partially embedded in the glue groove (14.1) is arranged on the glue groove (14.1), a glue roller driving motor (14.3) is arranged on one side of the driving glue roller (14.2) and is electrically connected to the PLC controller, and the other side of the driving glue roller (14.2) is meshed with the driven gear (14.5) via a driving gear (14.4) and is connected to the driven glue roller (14.6) via a driven shaft, the driving glue roller (14.2) is parallel to the driven glue roller (14.6) and the roller surfaces are arranged tangentially on the frame (1), and the position where the roller surfaces of the driving glue roller (14.2) are tangent to the driven glue roller (14.6) corresponds to the position where the yarn net (18) is arranged on the frame (1).

8. The medical paper production apparatus according to claim 2, wherein the pair of compound compression rollers (17) comprises an upper hollow compression roller (17.1) and a lower hollow compression roller (17.2), the hollow interiors of the upper hollow compression roller (17.1) and the lower hollow compression roller (17.2) are provided with an electric heater (17.3) and a temperature sensor (17.4) electrically connected to the PLC controller, the two ends of the upper hollow compression roller (17.1) and the lower hollow compression roller (17.2) are respectively supported on the frame (1) via an upper support seat (17.5) and a lower support seat (17.6), a guide rod (17.7) is provided between the upper support seat (17.5) and the lower support seat (17.6), a top pressing block (17.8) is provided at the upper end of the guide rod (17.7), a top pressing plate (17.9) slidingly fitted with the guide rod (17.7) is provided below the top pressing block (17.8), a top pressing spring (17.10) is provided between the top pressing plate (17.9) and the upper support seat (17.5), a screw hole is provided on the top pressing block (17.8), and the screw hole is in threaded engagement with a screw (17.11) having one end pressed against the top pressing plate (17.9) and the other end provided with a nut or an adjustment handle (17.12); one end of the upper hollow compression roller (17.1) and the lower hollow compression roller (17.2) are respectively provided with a driving gear (17.13) and a driven gear (17.14) meshed with each other, wherein the driving gear (17.13) is connected to a compression roller driving motor (17.16) via a flange (17.15), and the compression roller driving motor (17.16) is electrically connected to the PLC controller.

9. The medical paper production apparatus according to claim 2, wherein the reeling support (22), the upper layer medical paper unreeling support (19) and the lower layer medical paper unreeling support (20) of the compounded medical paper are all arranged between stand columns symmetrically arranged on the frame (1), a plurality of guide rollers (34) are respectively arranged between the reeling support (22), the upper layer medical paper unreeling support (19) and the lower layer medical paper unreeling support (20) and a pair of compound compression rollers (17), and the reeling support (22) is provided with a rolling driving mechanism (35); the reeling driving mechanism (35) comprises a reeling drum (35.1), a reeling mandrel (35.2) is provided at the center of the reeling drum (35.) and is supported on the frame (1), one end of the reeling mandrel (35.2) is connected to a reeling driving motor (35.3) provided on the frame (1), and the reeling driving motor (35.3) is electrically connected to the PLC controller.

10. The production process for producing medical paper using the medical paper production apparatus according to claim 9, wherein the production process comprises:
S1: placing the yarn spindle on a yarn spindle support (2);
S2: respectively placing the upper layer of medical paper (15) and the lower layer of medical paper (16) on the upper layer medical paper unreeling support (19) and the lower layer medical paper unreeling support (20);
S3: leading the yarn on the yarn spindle support (2) out, wherein a part of the yarn passes through the first warp comb plate (4) of the upper layer of yarn (3), the second guide comb plate (13) of the upper layer of yarn (3), the gluing mechanism (14) and a pair of compound compression rollers (17), a part of the yarn passes through the guide comb plate (8) of the lower layer of warps 7, the gluing mechanism (14) and a pair of compound compression rollers (17), and a part of the yarn passes through the guide comb plate (6) of the middle layer of wefts 5; the middle layer weft tensioning mechanism (9) and the middle layer weft steering support (10) are connected to a weft hook (11.6) on a synchronous driving belt (11.21) on a weft longitudinal driving mechanism (11) and a weft transverse driving mechanism (12);
S4: injecting glue into the glue groove (14.1) in the gluing mechanism (14);
S5: leading the upper layer of medical paper (15) on the upper layer medical paper unreeling support (19) out from the upper layer medical paper unreeling support (19) and respectively passing same through the upper layer medical paper unreeling tensioning mechanism (23) and a pair of compound compression rollers (17), and leading the lower layer of medical paper (16) on the lower layer medical paper unreeling support (20) out from the lower layer medical paper unreeling support (20) and respectively passing same through the lower layer medical paper unreeling tensioning mechanism (24) and a pair of compound compression rollers (17);
S6: leading the upper layer of medical paper (15), the yarn net (18) and the lower layer of medical paper (16) passing through the pair of compound compression rollers (17) together to pass through the reeling tensioning mechanism (25) and winding same on the reeling support (22), and after passing through the pair of compound compression rollers (17), separating the weft from the weft hook (11.6) via an unhooking mechanism or a weft cutting component;
S7: respectively starting a reeling driving motor (35.3) in a reeling driving mechanism (35) on a reeling support (22), a compression roller driving motor (17.16) in a pair of compound compression rollers (17), an electric heater (17.3) in the pair of compound compression rollers (17), a glue roller driving motor (14.3) in a gluing mechanism (14), a driving motor (11.5) of a pair of synchronous belts (11.1) in a weft longitudinal conveying driving mechanism (11) and a transverse driving motor (12.7) of a second synchronous conveyor belt (12.4) in a weft transverse driving mechanism (12) via the PLC controller;
S8: controlling the tension of the weft and the travelling speed of the weft by the PLC controller, and at the same time, controlling the unreeling tension of the upper layer of medical paper (15) and the lower layer of medical paper (16) and the reeling tension of the compounded medical paper (21) by the PLC controller, and measuring and controlling the temperature of the electric heater (17.3) in the pair of compound compression rollers (17) by the PLC controller; and
S9: adjusting the pressure between the pair of compound compression rollers (17) by manually adjusting a screw (17.11) on a top pressing plate (17.9) on the pair of compound compression rollers (17).

11. The production process for producing medical paper using the medical paper production apparatus according to claim 8, wherein the production process comprises:
S1: placing the yarn spindle on a yarn spindle support (2);
S2: respectively placing the upper layer of medical paper (15) and the lower layer of medical paper (16) on the upper layer medical paper unreeling support (19) and the lower layer medical paper unreeling support (20);
S3: leading the yarn on the yarn spindle support (2) out, wherein a part of the yarn passes through the first warp comb plate (4) of the upper layer of yarn (3), the second guide comb plate (13) of the upper layer of yarn (3), the gluing mechanism (14) and a pair of compound compression rollers (17), a part of the yarn passes through the guide comb plate (8) of the lower layer of warps 7, the gluing mechanism (14) and a pair of compound compression rollers (17), and a part of the yarn passes through the guide comb plate (6) of the middle layer of wefts 5; the middle layer weft tensioning mechanism (9) and the middle layer weft steering support (10) are connected to a weft hook (11.6) on a synchronous driving belt (11.21) on a weft longitudinal driving mechanism (11) and a weft transverse driving mechanism (12);
S4: injecting glue into the glue groove (14.1) in the gluing mechanism (14);
S5: leading the upper layer of medical paper (15) on the upper layer medical paper unreeling support (19) out from the upper layer medical paper unreeling support (19) and respectively passing same through the upper layer medical paper unreeling tensioning mechanism (23) and a pair of compound compression rollers (17), and leading the lower layer of medical paper (16) on the lower layer medical paper unreeling support (20) out from the lower layer medical paper unreeling support (20) and respectively passing same through the lower layer medical paper unreeling tensioning mechanism (24) and a pair of compound compression rollers (17);
S6: leading the upper layer of medical paper (15), the yarn net (18) and the lower layer of medical paper (16) passing through the pair of compound compression rollers (17) together to pass through the reeling tensioning mechanism (25) and winding same on the reeling support (22), and after passing through the pair of compound compression rollers (17), separating the weft from the weft hook (11.6) via an unhooking mechanism or a weft cutting component;
S7: respectively starting a reeling driving motor (35.3) in a reeling driving mechanism (35) on a reeling support (22), a compression roller driving motor (17.16) in a pair of compound compression rollers (17), an electric heater (17.3) in the pair of compound compression rollers (17), a glue roller driving motor (14.3) in a gluing mechanism (14), a driving motor (11.5) of a pair of synchronous belts (11.1) in a weft longitudinal conveying driving mechanism (11) and a transverse driving motor (12.7) of a second synchronous conveyor belt (12.4) in a weft transverse driving mechanism (12) via the PLC controller;
S8: controlling the tension of the weft and the travelling speed of the weft by the PLC controller, and at the same time, controlling the unreeling tension of the upper layer of medical paper (15) and the lower layer of medical paper (16) and the reeling tension of the compounded medical paper (21) by the PLC controller, and measuring and controlling the temperature of the electric heater (17.3) in the pair of compound compression rollers (17) by the PLC controller; and
S9: adjusting the pressure between the pair of compound compression rollers (17) by manually adjusting a screw (17.11) on a top pressing plate (17.9) on the pair of compound compression rollers (17).

12. The production process for producing medical paper using the medical paper production apparatus according to claim 7, wherein the production process comprises:
S1: placing the yarn spindle on a yarn spindle support (2);
S2: respectively placing the upper layer of medical paper (15) and the lower layer of medical paper (16) on the upper layer medical paper unreeling support (19) and the lower layer medical paper unreeling support (20);
S3: leading the yarn on the yarn spindle support (2) out, wherein a part of the yarn passes through the first warp comb plate (4) of the upper layer of yarn (3), the second guide comb plate (13) of the upper layer of yarn (3), the gluing mechanism (14) and a pair of compound compression rollers (17), a part of the yarn passes through the guide comb plate (8) of the lower layer of warps 7, the gluing mechanism (14) and a pair of compound compression rollers (17), and a part of the yarn passes through the guide comb plate (6) of the middle layer of wefts 5; the middle layer weft tensioning mechanism (9) and the middle layer weft steering support (10) are connected to a weft hook (11.6) on a synchronous driving belt (11.21) on a weft longitudinal driving mechanism (11) and a weft transverse driving mechanism (12);
S4: injecting glue into the glue groove (14.1) in the gluing mechanism (14);
S5: leading the upper layer of medical paper (15) on the upper layer medical paper unreeling support (19) out from the upper layer medical paper unreeling support (19) and respectively passing same through the upper layer medical paper unreeling tensioning mechanism (23) and a pair of compound compression rollers (17), and leading the lower layer of medical paper (16) on the lower layer medical paper unreeling support (20) out from the lower layer medical paper unreeling support (20) and respectively passing same through the lower layer medical paper unreeling tensioning mechanism (24) and a pair of compound compression rollers (17);
S6: leading the upper layer of medical paper (15), the yarn net (18) and the lower layer of medical paper (16) passing through the pair of compound compression rollers (17) together to pass through the reeling tensioning mechanism (25) and winding same on the reeling support (22), and after passing through the pair of compound compression rollers (17), separating the weft from the weft hook (11.6) via an unhooking mechanism or a weft cutting component;
S7: respectively starting a reeling driving motor (35.3) in a reeling driving mechanism (35) on a reeling support (22), a compression roller driving motor (17.16) in a pair of compound compression rollers (17), an electric heater (17.3) in the pair of compound compression rollers (17), a glue roller driving motor (14.3) in a gluing mechanism (14), a driving motor (11.5) of a pair of synchronous belts (11.1) in a weft longitudinal conveying driving mechanism (11) and a transverse driving motor (12.7) of a second synchronous conveyor belt (12.4) in a weft transverse driving mechanism (12) via the PLC controller;
S8: controlling the tension of the weft and the travelling speed of the weft by the PLC controller, and at the same time, controlling the unreeling tension of the upper layer of medical paper (15) and the lower layer of medical paper (16) and the reeling tension of the compounded medical paper (21) by the PLC controller, and measuring and controlling the temperature of the electric heater (17.3) in the pair of compound compression rollers (17) by the PLC controller; and
S9: adjusting the pressure between the pair of compound compression rollers (17) by manually adjusting a screw (17.11) on a top pressing plate (17.9) on the pair of compound compression rollers (17).

13. The production process for producing medical paper using the medical paper production apparatus according to claim 6, wherein the production process comprises:
S1: placing the yarn spindle on a yarn spindle support (2);
S2: respectively placing the upper layer of medical paper (15) and the lower layer of medical paper (16) on the upper layer medical paper unreeling support (19) and the lower layer medical paper unreeling support (20);
S3: leading the yarn on the yarn spindle support (2) out, wherein a part of the yarn passes through the first warp comb plate (4) of the upper layer of yarn (3), the second guide comb plate (13) of the upper layer of yarn (3), the gluing mechanism (14) and a pair of compound compression rollers (17), a part of the yarn passes through the guide comb plate (8) of the lower layer of warps 7, the gluing mechanism (14) and a pair of compound compression rollers (17), and a part of the yarn passes through the guide comb plate (6) of the middle layer of wefts 5; the middle layer weft tensioning mechanism (9) and the middle layer weft steering support (10) are connected to a weft hook (11.6) on a synchronous driving belt (11.21) on a weft longitudinal driving mechanism (11) and a weft transverse driving mechanism (12);
S4: injecting glue into the glue groove (14.1) in the gluing mechanism (14);
S5: leading the upper layer of medical paper (15) on the upper layer medical paper unreeling support (19) out from the upper layer medical paper unreeling support (19) and respectively passing same through the upper layer medical paper unreeling tensioning mechanism (23) and a pair of compound compression rollers (17), and leading the lower layer of medical paper (16) on the lower layer medical paper unreeling support (20) out from the lower layer medical paper unreeling support (20) and respectively passing same through the lower layer medical paper unreeling tensioning mechanism (24) and a pair of compound compression rollers (17);
S6: leading the upper layer of medical paper (15), the yarn net (18) and the lower layer of medical paper (16) passing through the pair of compound compression rollers (17) together to pass through the reeling tensioning mechanism (25) and winding same on the reeling support (22), and after passing through the pair of compound compression rollers (17), separating the weft from the weft hook (11.6) via an unhooking mechanism or a weft cutting component;
S7: respectively starting a reeling driving motor (35.3) in a reeling driving mechanism (35) on a reeling support (22), a compression roller driving motor (17.16) in a pair of compound compression rollers (17), an electric heater (17.3) in the pair of compound compression rollers (17), a glue roller driving motor (14.3) in a gluing mechanism (14), a driving motor (11.5) of a pair of synchronous belts (11.1) in a weft longitudinal conveying driving mechanism (11) and a transverse driving motor (12.7) of a second synchronous conveyor belt (12.4) in a weft transverse driving mechanism (12) via the PLC controller;
S8: controlling the tension of the weft and the travelling speed of the weft by the PLC controller, and at the same time, controlling the unreeling tension of the upper layer of medical paper (15) and the lower layer of medical paper (16) and the reeling tension of the compounded medical paper (21) by the PLC controller, and measuring and controlling the temperature of the electric heater (17.3) in the pair of compound compression rollers (17) by the PLC controller; and
S9: adjusting the pressure between the pair of compound compression rollers (17) by manually adjusting a screw (17.11) on a top pressing plate (17.9) on the pair of compound compression rollers (17).

14. The production process for producing medical paper using the medical paper production apparatus according to claim 5, wherein the production process comprises:
S1: placing the yarn spindle on a yarn spindle support (2);
S2: respectively placing the upper layer of medical paper (15) and the lower layer of medical paper (16) on the upper layer medical paper unreeling support (19) and the lower layer medical paper unreeling support (20);
S3: leading the yarn on the yarn spindle support (2) out, wherein a part of the yarn passes through the first warp comb plate (4) of the upper layer of yarn (3), the second guide comb plate (13) of the upper layer of yarn (3), the gluing mechanism (14) and a pair of compound compression rollers (17), a part of the yarn passes through the guide comb plate (8) of the lower layer of warps 7, the gluing mechanism (14) and a pair of compound compression rollers (17), and a part of the yarn passes through the guide comb plate (6) of the middle layer of wefts 5; the middle layer weft tensioning mechanism (9) and the middle layer weft steering support (10) are connected to a weft hook (11.6) on a synchronous driving belt (11.21) on a weft longitudinal driving mechanism (11) and a weft transverse driving mechanism (12);
S4: injecting glue into the glue groove (14.1) in the gluing mechanism (14);
S5: leading the upper layer of medical paper (15) on the upper layer medical paper unreeling support (19) out from the upper layer medical paper unreeling support (19) and respectively passing same through the upper layer medical paper unreeling tensioning mechanism (23) and a pair of compound compression rollers (17), and leading the lower layer of medical paper (16) on the lower layer medical paper unreeling support (20) out from the lower layer medical paper unreeling support (20) and respectively passing same through the lower layer medical paper unreeling tensioning mechanism (24) and a pair of compound compression rollers (17);
S6: leading the upper layer of medical paper (15), the yarn net (18) and the lower layer of medical paper (16) passing through the pair of compound compression rollers (17) together to pass through the reeling tensioning mechanism (25) and winding same on the reeling support (22), and after passing through the pair of compound compression rollers (17), separating the weft from the weft hook (11.6) via an unhooking mechanism or a weft cutting component;
S7: respectively starting a reeling driving motor (35.3) in a reeling driving mechanism (35) on a reeling support (22), a compression roller driving motor (17.16) in a pair of compound compression rollers (17), an electric heater (17.3) in the pair of compound compression rollers (17), a glue roller driving motor (14.3) in a gluing mechanism (14), a driving motor (11.5) of a pair of synchronous belts (11.1) in a weft longitudinal conveying driving mechanism (11) and a transverse driving motor (12.7) of a second synchronous conveyor belt (12.4) in a weft transverse driving mechanism (12) via the PLC controller;
S8: controlling the tension of the weft and the travelling speed of the weft by the PLC controller, and at the same time, controlling the unreeling tension of the upper layer of medical paper (15) and the lower layer of medical paper (16) and the reeling tension of the compounded medical paper (21) by the PLC controller, and measuring and controlling the temperature of the electric heater (17.3) in the pair of compound compression rollers (17) by the PLC controller; and
S9: adjusting the pressure between the pair of compound compression rollers (17) by manually adjusting a screw (17.11) on a top pressing plate (17.9) on the pair of compound compression rollers (17).

15. The production process for producing medical paper using the medical paper production apparatus according to claim 4, wherein the production process comprises:
S1: placing the yarn spindle on a yarn spindle support (2);
S2: respectively placing the upper layer of medical paper (15) and the lower layer of medical paper (16) on the upper layer medical paper unreeling support (19) and the lower layer medical paper unreeling support (20);
S3: leading the yarn on the yarn spindle support (2) out, wherein a part of the yarn passes through the first warp comb plate (4) of the upper layer of yarn (3), the second guide comb plate (13) of the upper layer of yarn (3), the gluing mechanism (14) and a pair of compound compression rollers (17), a part of the yarn passes through the guide comb plate (8) of the lower layer of warps 7, the gluing mechanism (14) and a pair of compound compression rollers (17), and a part of the yarn passes through the guide comb plate (6) of the middle layer of wefts 5; the middle layer weft tensioning mechanism (9) and the middle layer weft steering support (10) are connected to a weft hook (11.6) on a synchronous driving belt (11.21) on a weft longitudinal driving mechanism (11) and a weft transverse driving mechanism (12);
S4: injecting glue into the glue groove (14.1) in the gluing mechanism (14);
S5: leading the upper layer of medical paper (15) on the upper layer medical paper unreeling support (19) out from the upper layer medical paper unreeling support (19) and respectively passing same through the upper layer medical paper unreeling tensioning mechanism (23) and a pair of compound compression rollers (17), and leading the lower layer of medical paper (16) on the lower layer medical paper unreeling support (20) out from the lower layer medical paper unreeling support (20) and respectively passing same through the lower layer medical paper unreeling tensioning mechanism (24) and a pair of compound compression rollers (17);
S6: leading the upper layer of medical paper (15), the yarn net (18) and the lower layer of medical paper (16) passing through the pair of compound compression rollers (17) together to pass through the reeling tensioning mechanism (25) and winding same on the reeling support (22), and after passing through the pair of compound compression rollers (17), separating the weft from the weft hook (11.6) via an unhooking mechanism or a weft cutting component;
S7: respectively starting a reeling driving motor (35.3) in a reeling driving mechanism (35) on a reeling support (22), a compression roller driving motor (17.16) in a pair of compound compression rollers (17), an electric heater (17.3) in the pair of compound compression rollers (17), a glue roller driving motor (14.3) in a gluing mechanism (14), a driving motor (11.5) of a pair of synchronous belts (11.1) in a weft longitudinal conveying driving mechanism (11) and a transverse driving motor (12.7) of a second synchronous conveyor belt (12.4) in a weft transverse driving mechanism (12) via the PLC controller;
S8: controlling the tension of the weft and the travelling speed of the weft by the PLC controller, and at the same time, controlling the unreeling tension of the upper layer of medical paper (15) and the lower layer of medical paper (16) and the reeling tension of the compounded medical paper (21) by the PLC controller, and measuring and controlling the temperature of the electric heater (17.3) in the pair of compound compression rollers (17) by the PLC controller; and
S9: adjusting the pressure between the pair of compound compression rollers (17) by manually adjusting a screw (17.11) on a top pressing plate (17.9) on the pair of compound compression rollers (17).

16. The production process for producing medical paper using the medical paper production apparatus according to claim 3, wherein the production process comprises:
S1: placing the yarn spindle on a yarn spindle support (2);
S2: respectively placing the upper layer of medical paper (15) and the lower layer of medical paper (16) on the upper layer medical paper unreeling support (19) and the lower layer medical paper unreeling support (20);
S3: leading the yarn on the yarn spindle support (2) out, wherein a part of the yarn passes through the first warp comb plate (4) of the upper layer of yarn (3), the second guide comb plate (13) of the upper layer of yarn (3), the gluing mechanism (14) and a pair of compound compression rollers (17), a part of the yarn passes through the guide comb plate (8) of the lower layer of warps 7, the gluing mechanism (14) and a pair of compound compression rollers (17), and a part of the yarn passes through the guide comb plate (6) of the middle layer of wefts 5; the middle layer weft tensioning mechanism (9) and the middle layer weft steering support (10) are connected to a weft hook (11.6) on a synchronous driving belt (11.21) on a weft longitudinal driving mechanism (11) and a weft transverse driving mechanism (12);
S4: injecting glue into the glue groove (14.1) in the gluing mechanism (14);
S5: leading the upper layer of medical paper (15) on the upper layer medical paper unreeling support (19) out from the upper layer medical paper unreeling support (19) and respectively passing same through the upper layer medical paper unreeling tensioning mechanism (23) and a pair of compound compression rollers (17), and leading the lower layer of medical paper (16) on the lower layer medical paper unreeling support (20) out from the lower layer medical paper unreeling support (20) and respectively passing same through the lower layer medical paper unreeling tensioning mechanism (24) and a pair of compound compression rollers (17);
S6: leading the upper layer of medical paper (15), the yarn net (18) and the lower layer of medical paper (16) passing through the pair of compound compression rollers (17) together to pass through the reeling tensioning mechanism (25) and winding same on the reeling support (22), and after passing through the pair of compound compression rollers (17), separating the weft from the weft hook (11.6) via an unhooking mechanism or a weft cutting component;
S7: respectively starting a reeling driving motor (35.3) in a reeling driving mechanism (35) on a reeling support (22), a compression roller driving motor (17.16) in a pair of compound compression rollers (17), an electric heater (17.3) in the pair of compound compression rollers (17), a glue roller driving motor (14.3) in a gluing mechanism (14), a driving motor (11.5) of a pair of synchronous belts (11.1) in a weft longitudinal conveying driving mechanism (11) and a transverse driving motor (12.7) of a second synchronous conveyor belt (12.4) in a weft transverse driving mechanism (12) via the PLC controller;
S8: controlling the tension of the weft and the travelling speed of the weft by the PLC controller, and at the same time, controlling the unreeling tension of the upper layer of medical paper (15) and the lower layer of medical paper (16) and the reeling tension of the compounded medical paper (21) by the PLC controller, and measuring and controlling the temperature of the electric heater (17.3) in the pair of compound compression rollers (17) by the PLC controller; and
S9: adjusting the pressure between the pair of compound compression rollers (17) by manually adjusting a screw (17.11) on a top pressing plate (17.9) on the pair of compound compression rollers (17).

17. The production process for producing medical paper using the medical paper production apparatus according to claim 2, wherein the production process comprises:
S1: placing the yarn spindle on a yarn spindle support (2);
S2: respectively placing the upper layer of medical paper (15) and the lower layer of medical paper (16) on the upper layer medical paper unreeling support (19) and the lower layer medical paper unreeling support (20);
S3: leading the yarn on the yarn spindle support (2) out, wherein a part of the yarn passes through the first warp comb plate (4) of the upper layer of yarn (3), the second guide comb plate (13) of the upper layer of yarn (3), the gluing mechanism (14) and a pair of compound compression rollers (17), a part of the yarn passes through the guide comb plate (8) of the lower layer of warps 7, the gluing mechanism (14) and a pair of compound compression rollers (17), and a part of the yarn passes through the guide comb plate (6) of the middle layer of wefts 5; the middle layer weft tensioning mechanism (9) and the middle layer weft steering support (10) are connected to a weft hook (11.6) on a synchronous driving belt (11.21) on a weft longitudinal driving mechanism (11) and a weft transverse driving mechanism (12);
S4: injecting glue into the glue groove (14.1) in the gluing mechanism (14);
S5: leading the upper layer of medical paper (15) on the upper layer medical paper unreeling support (19) out from the upper layer medical paper unreeling support (19) and respectively passing same through the upper layer medical paper unreeling tensioning mechanism (23) and a pair of compound compression rollers (17), and leading the lower layer of medical paper (16) on the lower layer medical paper unreeling support (20) out from the lower layer medical paper unreeling support (20) and respectively passing same through the lower layer medical paper unreeling tensioning mechanism (24) and a pair of compound compression rollers (17);
S6: leading the upper layer of medical paper (15), the yarn net (18) and the lower layer of medical paper (16) passing through the pair of compound compression rollers (17) together to pass through the reeling tensioning mechanism (25) and winding same on the reeling support (22), and after passing through the pair of compound compression rollers (17), separating the weft from the weft hook (11.6) via an unhooking mechanism or a weft cutting component;
S7: respectively starting a reeling driving motor (35.3) in a reeling driving mechanism (35) on a reeling support (22), a compression roller driving motor (17.16) in a pair of compound compression rollers (17), an electric heater (17.3) in the pair of compound compression rollers (17), a glue roller driving motor (14.3) in a gluing mechanism (14), a driving motor (11.5) of a pair of synchronous belts (11.1) in a weft longitudinal conveying driving mechanism (11) and a transverse driving motor (12.7) of a second synchronous conveyor belt (12.4) in a weft transverse driving mechanism (12) via the PLC controller;
S8: controlling the tension of the weft and the travelling speed of the weft by the PLC controller, and at the same time, controlling the unreeling tension of the upper layer of medical paper (15) and the lower layer of medical paper (16) and the reeling tension of the compounded medical paper (21) by the PLC controller, and measuring and controlling the temperature of the electric heater (17.3) in the pair of compound compression rollers (17) by the PLC controller; and
S9: adjusting the pressure between the pair of compound compression rollers (17) by manually adjusting a screw (17.11) on a top pressing plate (17.9) on the pair of compound compression rollers (17).

18. The production process for producing medical paper using the medical paper production apparatus according to claim 1, wherein the production process comprises:
S1: placing the yarn spindle on a yarn spindle support (2);
S2: respectively placing the upper layer of medical paper (15) and the lower layer of medical paper (16) on the upper layer medical paper unreeling support (19) and the lower layer medical paper unreeling support (20);
S3: leading the yarn on the yarn spindle support (2) out, wherein a part of the yarn passes through the first warp comb plate (4) of the upper layer of yarn (3), the second guide comb plate (13) of the upper layer of yarn (3), the gluing mechanism (14) and a pair of compound compression rollers (17), a part of the yarn passes through the guide comb plate (8) of the lower layer of warps 7, the gluing mechanism (14) and a pair of compound compression rollers (17), and a part of the yarn passes through the guide comb plate (6) of the middle layer of wefts 5; the middle layer weft tensioning mechanism (9) and the middle layer weft steering support (10) are connected to a weft hook (11.6) on a synchronous driving belt (11.21) on a weft longitudinal driving mechanism (11) and a weft transverse driving mechanism (12);
S4: injecting glue into the glue groove (14.1) in the gluing mechanism (14);
S5: leading the upper layer of medical paper (15) on the upper layer medical paper unreeling support (19) out from the upper layer medical paper unreeling support (19) and respectively passing same through the upper layer medical paper unreeling tensioning mechanism (23) and a pair of compound compression rollers (17), and leading the lower layer of medical paper (16) on the lower layer medical paper unreeling support (20) out from the lower layer medical paper unreeling support (20) and respectively passing same through the lower layer medical paper unreeling tensioning mechanism (24) and a pair of compound compression rollers (17);
S6: leading the upper layer of medical paper (15), the yarn net (18) and the lower layer of medical paper (16) passing through the pair of compound compression rollers (17) together to pass through the reeling tensioning mechanism (25) and winding same on the reeling support (22), and after passing through the pair of compound compression rollers (17), separating the weft from the weft hook (11.6) via an unhooking mechanism or a weft cutting component;
S7: respectively starting a reeling driving motor (35.3) in a reeling driving mechanism (35) on a reeling support (22), a compression roller driving motor (17.16) in a pair of compound compression rollers (17), an electric heater (17.3) in the pair of compound compression rollers (17), a glue roller driving motor (14.3) in a gluing mechanism (14), a driving motor (11.5) of a pair of synchronous belts (11.1) in a weft longitudinal conveying driving mechanism (11) and a transverse driving motor (12.7) of a second synchronous conveyor belt (12.4) in a weft transverse driving mechanism (12) via the PLC controller;
S8: controlling the tension of the weft and the travelling speed of the weft by the PLC controller, and at the same time, controlling the unreeling tension of the upper layer of medical paper (15) and the lower layer of medical paper (16) and the reeling tension of the compounded medical paper (21) by the PLC controller, and measuring and controlling the temperature of the electric heater (17.3) in the pair of compound compression rollers (17) by the PLC controller; and
S9: adjusting the pressure between the pair of compound compression rollers (17) by manually adjusting a screw (17.11) on a top pressing plate (17.9) on the pair of compound compression rollers (17).
